(19) United States
(12) Patent Application Publication
(10) Pub. No.: US 2005/0005085 A1
(43) Pub. Date: Jan. 6, 2005

(54) Microprocessor using genetic algorithm

(75) Inventor: Akiharu Miyanaga, Hadano (JP)

Correspondence Address: ERIC ROBINSON, PMB 955, 21010 SOUTHBANK ST., POTOMAC FALLS, VA, 20165, US

(73) Assignee: Semiconductor Energy Laboratory Co., Ltd., Atsugi-shi (JP)

(21) Appl. No.: 10/878,011

(22) Filed: Jun. 29, 2004

(30) Foreign Application Priority Data
Jul. 4, 2003 (JP) 2003-271180

(51) Int. Cl. G06F 15/76; G06F 15/00; G06F 15/18; G06N 3/12; G06N 3/00

(52) U.S. Cl. 712/32; 706/13

(57) ABSTRACT

The present invention reduces overhead in a VLIW type microprocessor including a dynamic compiler or controls a memory capacity for storing an object code after scheduling. The present invention relates to a VLIW microprocessor including a dynamic compiler and improves operation performance of a microprocessor by executing instructions more efficiently. Specifically, one feature of the present invention is to reduce overhead accompanying execution of a dynamic compiler and to control a memory capacity for storing an object code after scheduling internal instructions by using genetic algorithm (GA) in an execution of instructions in a VLIW microprocessor including a dynamic compiler.

### BACKGROUND OF THE INVENTION

1. Field of the Invention

The present invention relates to a technology that can improve the process efficiency in a VLIW (Very Long Instruction Word) type microprocessor including a dynamic compiler.

2. Description of the Related Art

Conventionally, Out-of-Order type superscalar architecture has been often used for an x86-compatible processor. This Out-of-Order is a function executing an instruction regardless of an instruction execution sequence described in an object code, and needs a function for inspecting that there is no dependency between instructions, and a function which orders an operation result of executed instructions in a sequence described in the object code. In addition, a superscalar is a function executing two or more instructions simultaneously. Because the average number of instructions to be executed in one cycle increases, in comparison with a microprocessor which executes only one instruction, a high operation function can be shown at the same operating frequency.

However, because news on an x86-compatible processor Crusoe of Transmeta corporation in U.S. has been reported all over the world in January, 2000, a big flow since architecture migration from CISC (Complex Instruction Set Computer) to RISC (Reduced Instruction Set Computer) appears in the flow of the later processor architecture.

Processor architecture of Crusoe adopts VLIW (Very Long Instruction Word), and an X86-compatibility object code is translated into an VLIW code at an execution time by a run time software program that is called Code Morphing Software and emulation is conducted in the VLIW processor. As a feature accompanying this, there is low power consumption. By employing simple VLIW architecture instead of complex Out-of-Order type superscalar architecture, dynamic power supply voltage optimization referred to as “LongRun Technology” by Transmeta corporation is adopted as well as reducing the number of transistors to be needed to half.

Here, a VLIW technology is architecture to describe in parallel a process using plural operational units by a long format instruction such as 128 bits or 256 bits, and a process of four or eight 32-bit instructions is possible by one instruction, for example. This technology is the technology that Josh Fisher has announced for the first time in 1978.

Code translation technology using a software or the VLIW technology that is an elemental technology described above is worthy of attention, but individual technology itself is not so new technology. It is important that the notable technical value in Crusoe is a VLIW type microprocessor including a dynamic compiler. This is because technical problems are caused when a simple combination of a VLIW technology and a code translation technology is conducted. The problem is a time and space overhead of a code translation. For example, the time overhead is a time that is needed to translate an x86 object code into a native VLIW code, and the space overhead is a size that a code translation software itself occupies in a main memory and a memory size that is needed for caching the translated VLIW code on the main memory. Specifically, the problem about time overhead is serious, and only several tens percents of performance of a processor to be executed directly is generally given.

Transmeta Corporation solves the problems about overhead by employing a dynamic binary code translation technique. The dynamic compiler technique supplements optimization by a conventional static compiler technique. The dynamic compiler technique is a software to translate into an object code which is optimized for a particular microprocessor by performing instruction scheduling on the object code of a program.

The technique to eliminate a bottleneck of hardware by software is described more concretely with reference to FIGS. 1A and 1B. In a superscalar type microprocessor of FIG. 1A, instruction scheduling is constituted in hardware, which is a bottleneck. On the contrary, because the VLIW processor including a dynamic compiler as shown in FIG. 1B carries out scheduling of an internal instruction in software, a circuit for scheduling an internal instruction is not needed in hardware. Thus, circuits become simple in hardware and it becomes easy to increase the operating frequency for the hardware. By the way, the operation performance of a processor is expressed by the next equation 1.
(Operation Performance)=(Operating Frequency)×(the Average Number of Instructions to be executed in one cycle) [Equation 1]

A VLIW processor including a dynamic compiler is superior from a point of view that the average number of instructions to be executed in one cycle can be increased. The greatest advantage is that the degree of freedom of scheduling is large. This is described with reference to FIGS. 2A and 2B.

As shown in FIG. 2A, instructions which are fetched from a main memory are stored once in a buffer that is referred to as a reorder buffer in a superscalar type microprocessor. Instructions which can be executed simultaneously are selected and sent into an operational unit from the stored instructions by an Out-of-order executive function. However, only about several tens to one hundred and several tens instructions can be stored in the reorder buffer, and thus, it is hard to find the instructions which can be executed simultaneously. In other words, the degree of freedom of scheduling is limited by a capacity of the reorder buffer which a microprocessor can integrate, in scheduling by hardware.

On the contrary, as shown in FIG. 2B, by using a dynamic compiler that can select instructions which can be executed simultaneously from many instructions stored in a main memory, the probability of discovering instructions which can be executed simultaneously becomes high. In other words, when the same object code is executed, the average number of instructions to be executed in one cycle in the VLIW microprocessor including a dynamic compiler can be more increased, as compared with a superscalar type microprocessor The average number of instructions to be executed in one cycle is expressed by IPC, TCM, and DCO as expressed in the next equation 2, and what is described above means reduction of IPC. IPC, TCM and DCO mean the number of cycles required for execution of one instruction, error rate of a translation cache, and overhead of a dynamic compiler, respectively.
(Average Number of Instructions to be executed in one cycle)=1/(IPC+TCM×DCO) [Equation 2]

TCM can be reduced by increase of a cache capacity. Reduction of DCO is advantageous for a dynamic compiler. Depending on program execution circumstances, overhead of a dynamic compiler can be reduced by detecting an instruction path to be executed repeatedly, and by scheduling and optimizing the instruction path intensively. Besides, when an object code that has been optimized once is stored in a cache, it is unnecessary to use a dynamic compiler in the next execution and overhead after that can be dramatically reduced. Crusoe is made considering the points. In Crusoe, some additional functions of hardware are added to increase the efficiency of a dynamic compiler. They are a shadow register function and a store buffer function with a gate. Thus, exception at the time of a speculation process can be carried out precisely. Details thereof are described in U.S. Pat. No. 6,031,992 and the like. In addition, a translated bit or a mechanism of Alias detection is included in Crusoe.

In a VLIW type microprocessor including a dynamic compiler typified by Crusoe, the dynamic compiler is considerably devised and an effort to reduce overhead is made as described above. However, such a VLIW type microprocessor including a dynamic compiler does not have efficiency enough to substitute for a superscalar type microprocessor. In other words, there are still many problems in conventional dynamic compilers.

### SUMMARY OF THE INVENTION

Herein, it is an object of the present invention to reduce more overhead accompanying execution of a dynamic compiler and to control a memory capacity for storing an object code after scheduling. As a result, operation performance of a microprocessor can be enhanced by increasing the average number of instructions to be executed in one cycle.

The present invention relates to a VLIW microprocessor including a dynamic compiler and improves operation performance of a microprocessor by executing instructions more efficiently. Specifically, one feature of the present invention is to reduce overhead accompanying execution of a dynamic compiler and to control a memory capacity for storing an object code after scheduling internal instructions by using genetic algorithm (GA) in an execution of instructions in a VLIW microprocessor including a dynamic compiler.

Accordingly, a microprocessor of the present invention comprises a hardware area and a software area, and genetic algorithm is used in the software area.

In the above structure, a dynamic compiler is included in the software area and genetic algorithm is employed as a process of the dynamic compiler.

In the above structure, a dynamic compiler included in the software area conducts a plurality of processes including instruction branch prediction, selection of an instruction path, scheduling of an internal instruction and optimization, and genetic algorithm is used for one of the plurality of processes.

In addition, structures of the present invention include a case where the software area includes a dynamic compiler and a genetic algorithm engine and a case where a dynamic compiler is included in the software area and a genetic algorithm engine is included in the dynamic compiler in the above structure.

Further, the genetic algorithm engine comprises a unit for determining initial groups, a unit for evaluating the initial groups, a unit for selecting an object to be evaluated according to fitness of evaluation, a unit for conducting genetic operations such as crossover and mutation, and a unit for evaluating again whether the sequence of processes is continued or not.

Genetic algorithm (GA) is a method for optimizing software by imitating the process of evolution of creatures. One conception thereof is that a more excellent gene is led by repeating heredity and natural selection. In genetic algorithm, firstly some initial groups which have different genes, are prepared and three processes of selection, crossover, and mutation are performed among them. Selection is to select excellent groups from the initial groups. Crossover is that a part of genes is exchanged at random in the selected groups. Mutation happens with low probability and is to rewrite a part of gene information at random. Specifically, the flow of the processes are shown hereinafter.
1. Some algorithms to be base are prepared.
2. Fitness is calculated every individual.
3. If the condition is met, it ends. If it is not met, go to 4.
4. Crossover of genes of an individual selected at random from excellent individual groups is executed.
5. Judgment is made whether mutation happens or not, and mutation is performed according to the judgment.
6. Go back to 2.

In other words, only an individual having excellent genes is selected from initial groups by performing natural selection and reproductive activity. That is a method for searching for an optimum solution immediately and randomly for engineering. The application range of genetic algorithm is extremely wide, and includes search in the wide range, optimization problem, a learning problem of a machine, and the like. Further, genetic algorithm can be combined with other methods with good compatibility.

The present invention is effective in reducing overhead of a dynamic compiler by performing optimization that includes instruction branch prediction and an internal instruction scheduling by using a genetic algorithm technique in a VLIW type microprocessor including a dynamic compiler, which comprises hardware and software. In addition, it is possible to reduce overhead and optimize a content or a capacity of a cache by using a learning function of genetic algorithm together.

These and other objects, features and advantages of the present invention become more apparent upon reading of the following detailed description along with the accompanying drawings.

### BRIEF DESCRIPTION OF THE DRAWINGS

In the accompanying drawings:

FIGS. 1A and 1B show a comparison of hardware configurations of a superscalar type microprocessor and a VLIW type microprocessor including a dynamic compiler;

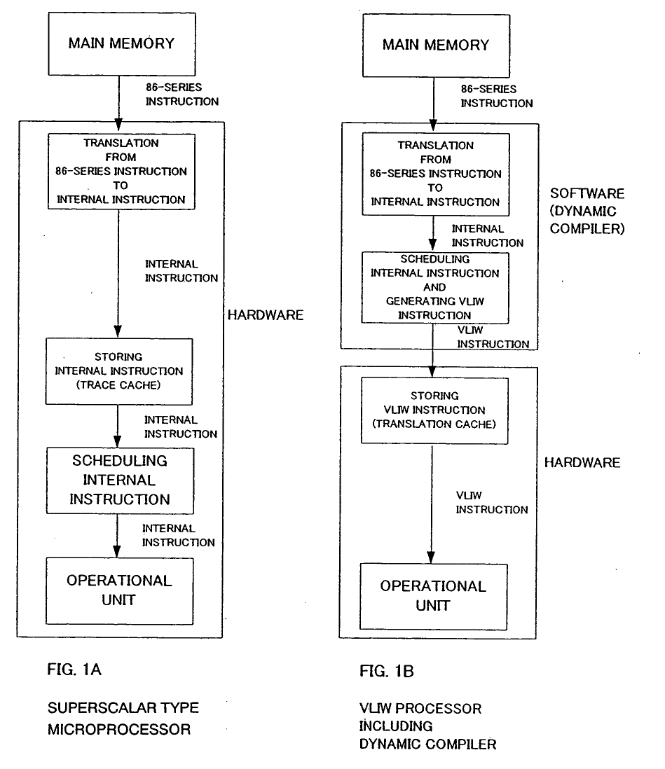

FIGS. 2A and 2B show a comparison of instruction scheduling of a superscalar type microprocessor and a VLIW type microprocessor comprising a dynamic compiler;

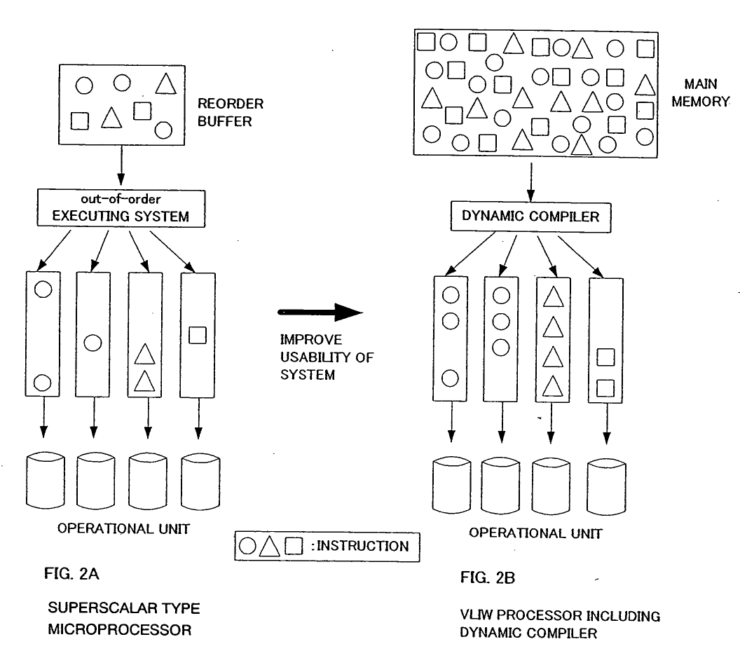

FIGS. 3A and 3B are configuration diagrams of a VLIW type microprocessor including a dynamic compiler and a periphery thereof;

FIG. 4 is a conceptual diagram showing a pipeline system;

FIG. 5 is a conceptual diagram showing a flow of a pipeline system in the case of a branch instruction;

FIG. 6 shows an example of selection of an instruction path in programming;

FIGS. 7A and 7B each show a configuration of a software area of a processor;

FIG. 8 is a flowchart of basic genetic algorithm;

FIGS. 9A and 9B each show examples of crossover of genetic algorithm;

FIG. 10 shows an example of mutation of genetic algorithm;

FIG. 11 is a flowchart showing that a source code is an object code-translated to an execution unit;

FIG. 12 is a flowchart about cache storing of a translated object code; and

FIGS. 13A to 13E each show electronic devices using a microprocessor of the present invention.

### DETAILED DESCRIPTION OF THE INVENTION

Embodiment Mode

Embodiment mode of the present invention is described with reference to the drawings.

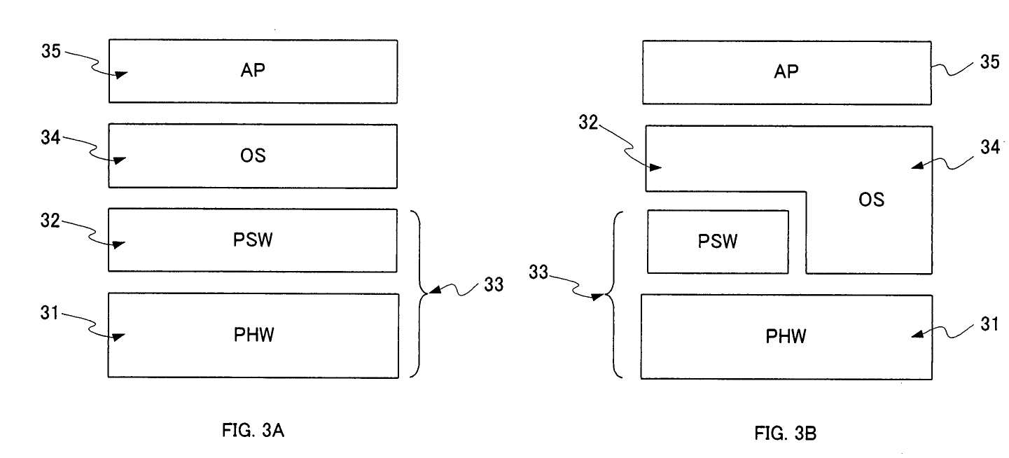

At first, a configuration of a VLIW type microprocessor including a dynamic compiler of the present invention is described. A peripheral configuration diagram including a microprocessor of the present invention is shown in FIGS. 3A and 3B.

As shown in FIGS. 3A and 3B, a microprocessor 33 of the present invention comprises a hardware area (PHW) 31 and a software area (PSW) 32. The hardware area includes a VLIW architecture structure. A dynamic compiler area is included in the software area and it is a main area of the present invention. There is an operating system (OS) 34 above the software area, and there is a general application (AP) 35 above it. In some cases, the operation system directly accesses to the hardware area as shown in FIG. 3B.

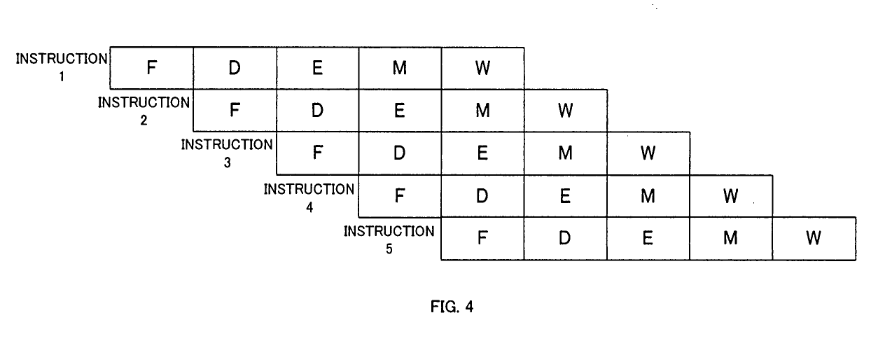

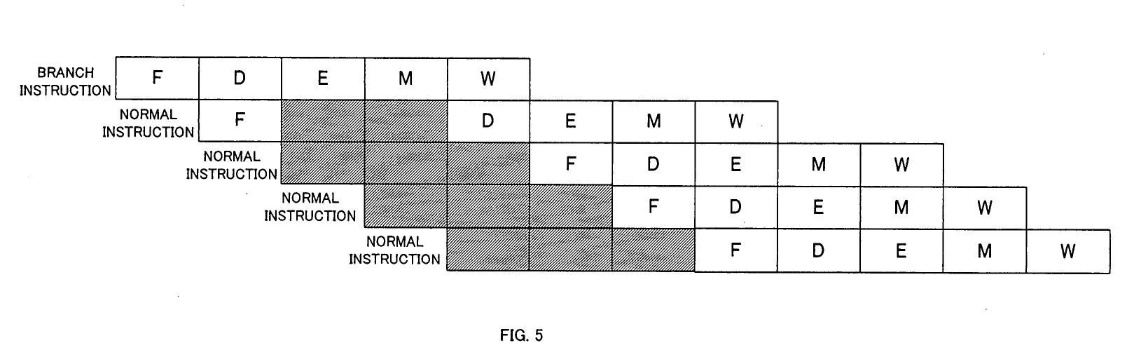

Basic operations of a microprocessor generally includes five stages: (1) Fetch: read-in of an instruction, (2) Decode: analysis of the instruction, (3) Execution: execution of an operation, (4) Memory: reference of a memory, (5) Write: writing-in of the operation result. However, it is inefficient that the next instruction is not executed until all operations are finished. Thus, it is possible to enhance the efficiency by sending instructions to each of the operations continuously. This is a pipeline system shown in FIG. 4. In FIG. 4, F denotes read-in of an instruction, D denotes analysis of the instruction, E denotes execution of an operation, M denotes reference of a memory, and W denotes writing-in of the operation result. One instruction is needed to be fetched every clock cycle so as not to stop a pipeline of a microprocessor. However, there is a control hazard that stops this pipeline flow. There is a hazard due to branch as one of the control hazards. This is because it is not understood whether the branch is concluded or not until a stage of reference of a memory in the pipeline (“M” operation in FIG. 5), when the branch instruction is executed.

FIG. 5 shows a pipeline flow of the case where a branch instruction is given. Here, it is shown that stall (shadow area in FIG. 5) of three clocks is generated. Since the speed slows too down when the pipeline is stalled until the branch is finished as shown by an example of FIG. 5, execution of a following instruction is continued by predicting a result of the branch in advance. When the prediction is missed, the instruction which comes to halfway is flushed and another instruction is needed to be fetched again. It is necessary to increase the precision of branch prediction to reduce a cost of such a control hazard, which directly leads to overhead reduction of a dynamic compiler.

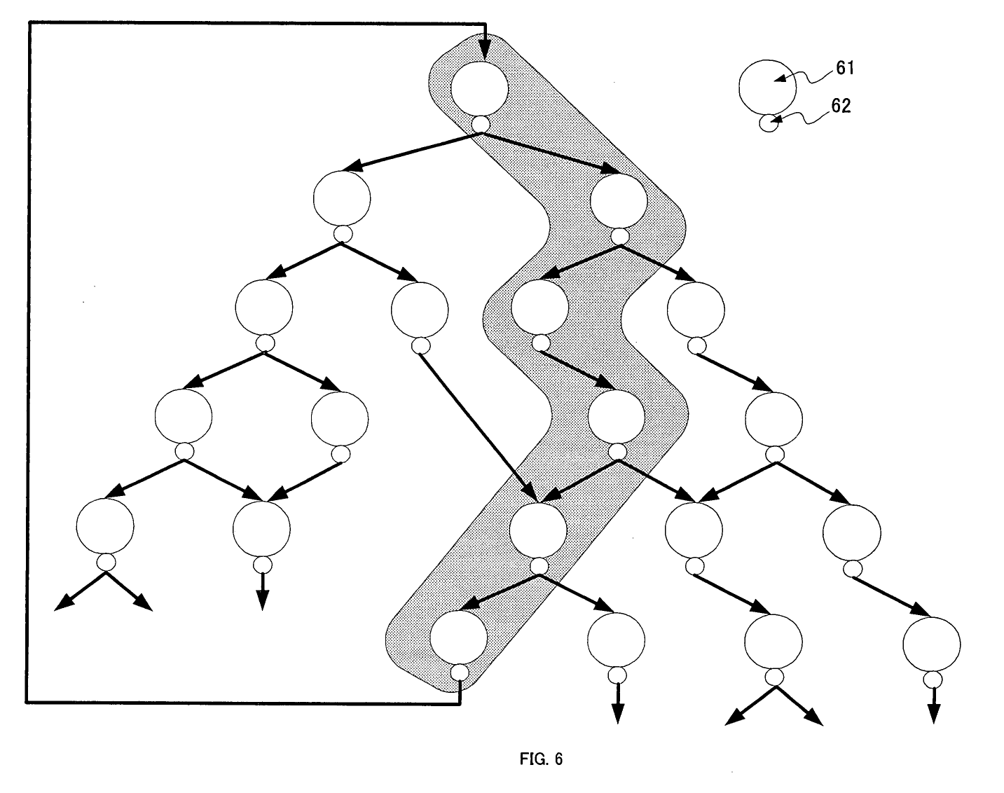

In addition, there is a small number of instructions that are actually executed in a microprocessor, among instructions constituting an object code in almost all programs. It leads to reduction of overhead of a dynamic compiler to find and optimize an instruction path that is made up of the actual instructions. FIG. 6 shows an example of a selected instruction path. Reference numeral 61 is a basic block and reference numeral 62 denotes an instruction branch in a node in FIG. 6

The dynamic compiler executes instruction scheduling and optimization in the wider sense, in addition to the above described branch prediction or selection of an instruction path. Further, it also controls many processes such as allocation of a data address or an allotment of a register.

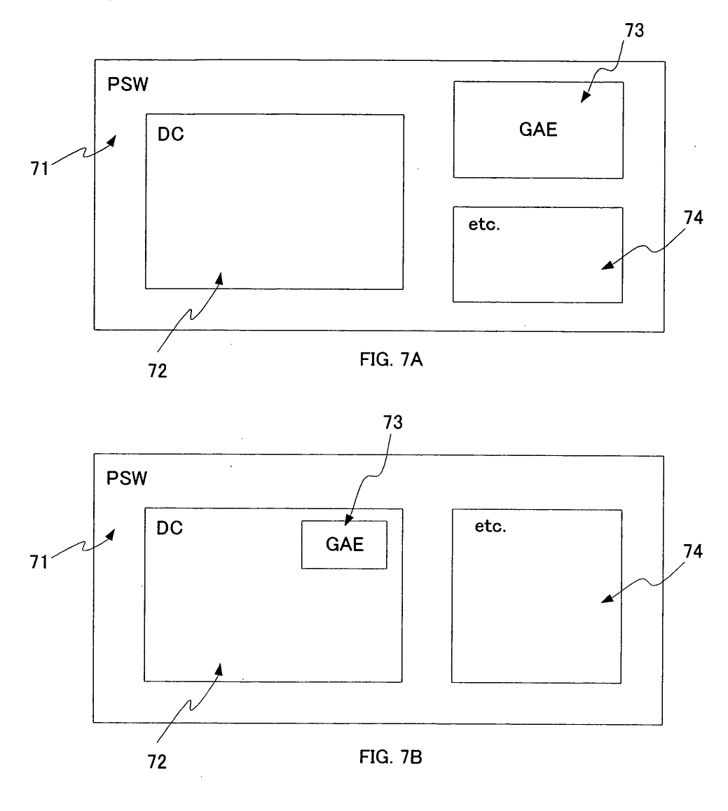

According to the present invention, reduction of overhead of a dynamic compiler is aimed by increasing the efficiency of branch prediction, instruction scheduling or the like with genetic algorithm (GA). Specifically, the inside of the software area of the microprocessor is configured as shown in FIGS. 7A and 7B show. Reference numeral 71 in FIG. 7A denotes a PSW like 32 in FIGS. 3A and 3B. The PSW includes a dynamic compiler 72 and etc. 74, but a genetic algorithm engine (GAE) 73 may exist outside of the dynamic compiler (FIG. 7A) or inside of the dynamic compiler (FIG. 7B).

As described above, genetic algorithm (GA) is a method for obtaining a solution that is optimized for a problem. This method is made by imitating a law of heredity in the world of creatures proposed by John H. Holland and a method for obtaining a better solution by changing plural solutions genetically.

A solution is expressed with a gene in GA. The feature of a solution is described depending on a particular rule. Specifying genes by determining this rule is referred to as coding and the coding is important from the point of how the problems are expressed. In the case where coding is fault or is not suitable for a problem, effective result is not expected. Commonly, a binary code is often used as a coded gene expression. In the present invention, a binary code is suitable for the coded mode in view of a target problem and a request for memory reduction.

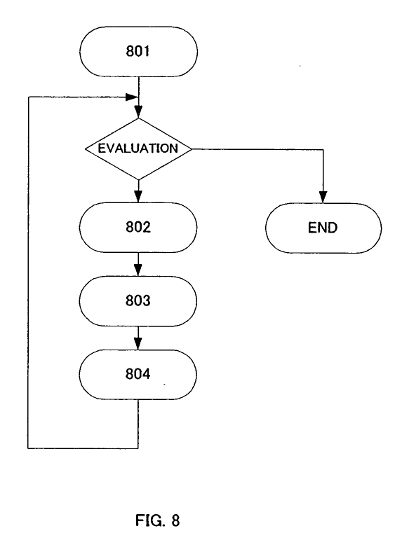

FIG. 8 shows an example of a basic GA flowchart. Note that this is only an example, and is not limited to this. At first, initial groups are prepared at the beginning of the flow. The initial group is a group of solutions, namely, a group of coded genes expression, and is referred to as a population in GA. The population that is the initial group is not specified data, but data made at random, or some prepared data. The initial groups are only required to have diversity. In other words, since it is an aim to obtain a global optimum solution by genetic operation, if patterns are provided as variously as possible, the possibility of searching is greater, that is, reducing the risk of falling into local optimum solutions. Next, evaluation is conducted. When certain conditions are fulfilled, for example, the case where the present population includes a solution to fulfill the conditions, GA finishes. It is possible to prevent GA from continuing in the case where conditions of evaluating a solution are severe, when a solution and a generation of GA (the number of calculation) are prepared as the finish conditions.

In selection, fitness of all individuals (solutions) in a population is obtained, and an individual to be left for the next generation is determined based on this fitness. The fitness shows degree of evaluation of a solution. The method varies depending on a problem, but an evaluation function is determined so that higher degree of fitness is obtained with a more preferable solution. In addition, there are various methods for selection. It is desirable that a suitable method is selected depending on a problem. In general, it seems that it is thought to be easy to evaluate by changing a solution into phenotype. Crossover and mutation are referred to as a GA operator and characterize GA. The both are made based on a law of heredity as hints. In crossover, a new individual (child) inheriting genes from plural parents (in general, two parents) is formed. Mutation occurs with low probability and changes a part of genes.

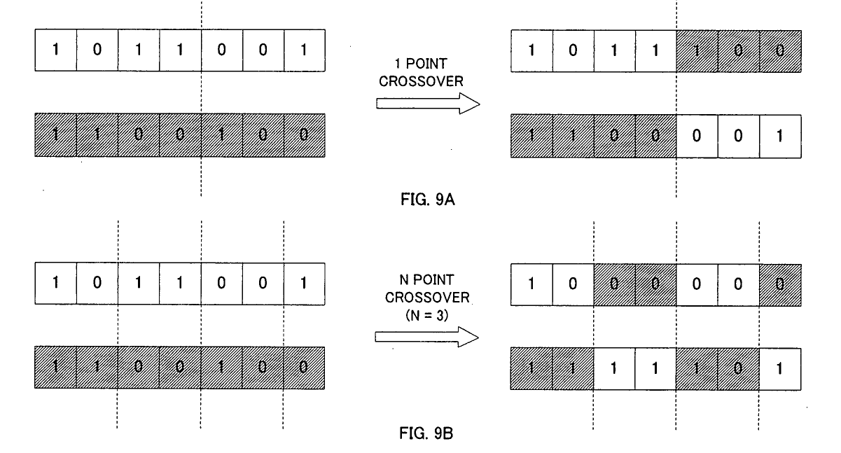

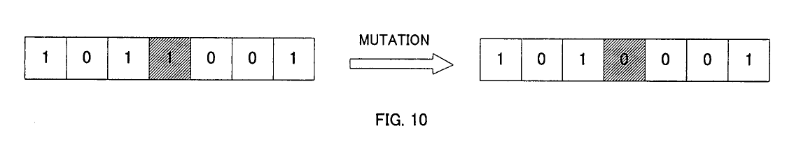

FIGS. 9A and 9B show conceptual diagrams of crossover. In general, there are many cases to perform one point of crossover, but like FIG. 9B, N points of crossover (N denotes a positive integer) are possible. In addition, FIG. 10 shows an example of mutation.

Here, it is a purpose of crossover to create a better gene by inheriting separate preferable characters from both parents, and a purpose of mutation is to prevent genes from falling into a local optimum solution and to search for a most suitable solution in a wider range. Genes are only changed in various ways only by repeating crossover and mutation, but because system is such that an individual having low fitness is sequentially weeded out by selection, consequently, individuals which have made positive changes can survive. Selection similar to evolution of creatures in the natural world just occurs.

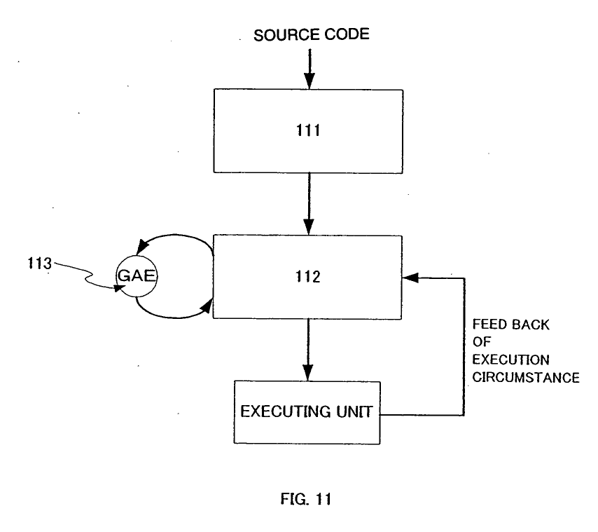

By using the above described genetic algorithm, the configurations in FIGS. 7A and 7B are shown as the structure for reducing overhead of a dynamic compiler in a microprocessor software area PSW. Meanwhile, FIG. 11 shows a concrete flow in which a source code is object code-translated to an execution unit. A static compiler 111 which is inherent in an instruction set and a dynamic compiler 112 which is inherent in a hardware in the figure generate object codes, but in the present invention, 112 is especially important. The execution unit feeds back execution circumstances to 112, and the 112 generates an optimized object code. In this case, genetic algorithm is employed, but the engine may be in the dynamic compiler, and may be outside and be treated as a support function like 113 in the figure.

Incidentally, an important function can be added, in addition to optimizing by using genetic algorithm. Genetic algorithm can also have a learning function. A learning function that conduct instruction scheduling or selection of an instruction path suitable for an individual user or an individual time can be added by using this function.

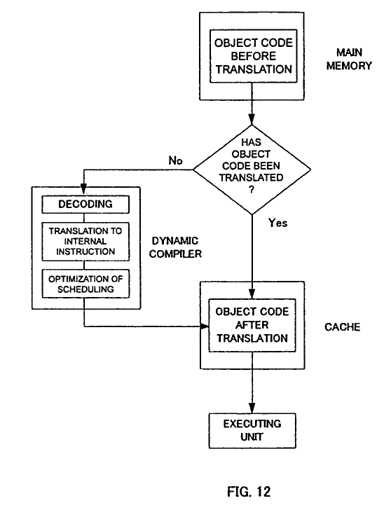

These functions can be applied to a case of having a function to put a translated object code in a cache as shown in FIG. 12. As a technique for determining criteria for putting a translated object code in the cache and for erasing it, genetic algorithm is used. In addition, when a cache capacity is different depending on an application, the most suitable criteria can be chosen by employing genetic algorithm. The cache function as shown in FIG. 12 is a very effective function for overhead reduction and can improve the performance of a microprocessor markedly.

Embodiments of the present invention are described hereinafter.

[Embodiment 1]

A genetic algorithm engine (GAE) of FIG. 11 or FIGS. 7A and 7B of the present invention is described in this embodiment.

FIGS. 7A and 7B each show a software area of a microprocessor of the present invention. Reference numeral 71 in FIG. 7 shows a PSW like 32 in FIG. 3, which comprises etc. 74 and a dynamic compiler 72. And a dynamic genetic algorithm engine 73 may be outside (in FIG. 7A) or inside (FIG. 7B.) of the dynamic compiler 72. In addition, FIG. 11 shows a concrete relation of a genetic algorithm engine and a dynamic compiler which object code-translate a source code into an execution unit. A flowchart of a genetic algorithm engine is shown in FIG. 8 typically. However, FIG. 8 shows the simplest algorithm among genetic algorithms, but convergence time and legality for obtaining an optimum solution are increased by arranging the genetic algorithm to some extent.

A flow of FIG. 8 is described by using the case of conducting an instruction schedule as an example. It is necessary to determine initial groups 801 first. It is a so-called coding operation. An instruction sequence is translated into a form suitable for a process in a program, and a genetic expression is generated based on this. An instruction sequence designated as the genetic expression is actually executed, and the time is made as an object to be evaluated. Priority is determined according to fitness of the instruction sequence evaluated by selection 802. After conducting a genetic operation such as crossover 803 or mutation 804, an execution time is evaluated again, and a new instruction sequence is allowed to do alternation of generations. Only old generation individuals having a short execution time are allowed to remain continuously in the next generation in alternation of generations, and the other ones except for them are replaced by new generation individuals. After this, selection and a genetic operation are performed on this new generation instruction sequence again. This genetic operation is performed repeatedly until convergence conditions are satisfied. There is a case where an execution time is arranged beforehand or a case where the number of alternation of generations is determined as the convergence conditions. After fulfilling the convergence conditions, a group having a shortest execution time from instruction sequence groups generated by this is an instruction sequence to be a purpose. Because a flow here is simplest, it is not always necessary to employ such a flow.

[Embodiment 2]

A microprocessor including a dynamic compiler using genetic algorithm can be used in various portable electronic devices including a personal computer, since it is suitable for achieving low power consumption.

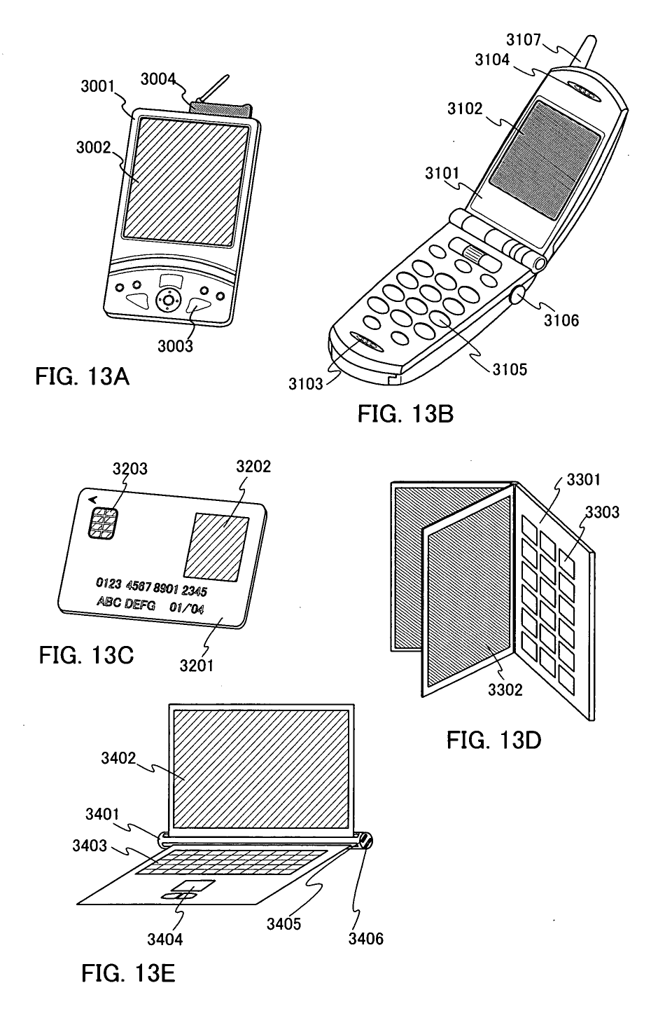

Electronic devices using a microprocessor of the present invention include a video camera, a digital camera, a goggle type display (head mounted display), a navigation system, an audio player (such as a car audio compo or an audio compo), a laptop computer, a game machine, a persona digital assistant (such as a mobile computer, a cellular telephone, a portable game machine or an electronic book), an image reproducing device provided with a recording medium (typically, a device provided with a display that can reproduce a recording medium such as a DVD (digital versatile disc) and display the image) and the like. In particular, a mechanism of the dynamic compiler which is evolved by an individual user is important since a personal digital assistant is used differently depending on an individual user. Practical examples of such electronic devices are shown in FIGS. 13A to 13E.

FIG. 13A shows a personal digital assistant including a main body 3001, a display portion 3002, an operation key 3003, a modem 3004 and the like. Although a personal digital assistant having the demountable modem 3004 is shown in FIG. 13A, a modem may be incorporated in the main body 3001. The microprocessor of the present invention can be employed as a component part inside the main body.

FIG. 13B shows a cellular telephone including a main body 3101, a display portion 3102, an audio input portion 3103, an audio output portion 3104, an operation key 3105, an external connection port 3106, an antenna 3107 and the like. Note that when the display portion 3102 displays white letters on black background, the cellular telephone consumes less power. The microprocessor of the present invention can be employed as a component part inside the main body.

FIG. 13C shows an electronic card including a main body 3201, a display portion 3202, a connection terminal 3203 and the like. The microprocessor of the present invention can be employed as a component part inside the main body. It should be noted that, although a contact type electronic card is shown in FIG. 13C, the microprocessor of the present invention can be applied to a noncontact type electronic card or an electronic card having contact type and noncontact type functions.

FIG. 13D shows an electronic book including a main body 3301, a display portion 3302, an operation key 3303 and the like. In addition, a modem may be incorporated in the main body 3301. The microprocessor of the present invention can be employed as a component part inside the main body.

FIG. 13(E) shows a sheet type personal computer including a main body 3401, a display portion 3402, a key-board 3403, a touch pad 3404, an external connection port 3405, a plug for power supply 3406 and the like. The microprocessor of the present invention can be employed as a component part inside the main body.

As described above, the application range of the present invention is extremely wide and can be used in electronic devices in all fields. This application is based on Japanese Patent Application serial no. 2003-271180 filed in Japan Patent Office on 4, Jul., 2003, the contents of which are hereby incorporated by reference.

Although the present invention has been fully described by way of Embodiment Mode and Embodiments with reference to the accompanying drawings, it is to be understood that various changes and modifications will be apparent to those skilled in the art. Therefore, unless such changes and modifications depart from the scope of the present invention hereinafter defined, they should be constructed as being included therein.

1. A microprocessor comprising:
a software area translating a first instruction set to a second instruction set; and
a hardware area executing the second instruction set, wherein:
the software area includes a genetic algorithm engine, and
the genetic algorithm engine optimizes the translation of the software area.

2. A microprocessor according to claim 1, wherein the genetic algorithm engine comprises:
a means for determining initial groups;
a means for evaluating the initial groups;
a means for selecting an object to be evaluated according to fitness of evaluation;
a means for conducting genetic operations such as crossover and mutation; and
a means for evaluating again whether the sequence of processes is continued or not.

3. A microprocessor comprising:
a software area translating a first instruction set to a second instruction set; and
a hardware area executing the second instruction set, wherein:
the software area includes a dynamic compiler and a genetic algorithm engine,
the dynamic compiler generates the second instruction set, and
the genetic algorithm engine optimizes the generation of the dynamic compiler.

4. A microprocessor according to claim 3, wherein the genetic algorithm engine is included in the dynamic compiler.

5. A microprocessor according to claim 3, wherein:
the dynamic compiler comprises:
a means for predicting instruction branches;
a means for selecting an instruction path;
a means for scheduling an internal instruction; and
a means for optimizing the internal instruction, and
the genetic algorithm engine optimizes at least one selected from a group comprising the means for predicting, the means for selecting, the means for scheduling, and the means for optimizing.

6. A microprocessor according to claim 3, wherein the genetic algorithm engine comprises:
a means for determining initial groups;
a means for evaluating the initial groups;
a means for selecting an object to be evaluated according to fitness of evaluation;
a means for conducting genetic operations such as crossover and mutation; and
a means for evaluating again whether the sequence of processes is continued or not.

7. A VLIW type microprocessor comprising:
a software area translating a first instruction set to a second instruction set; and
a hardware area executing the second instruction set, wherein:
the software area includes a genetic algorithm engine, and
the genetic algorithm engine optimizes the translation of the software area.

8. A VLIW type microprocessor according to claim 7, wherein the genetic algorithm engine comprises:
a means for determining initial groups;
a means for evaluating the initial groups;
a means for selecting an object to be evaluated according to fitness of evaluation;
a means for conducting genetic operations such as crossover and mutation; and
a means for evaluating again whether the sequence of processes is continued or not.

9. A VLIW type microprocessor comprising:
a software area translating a first instruction set to a second instruction set; and
a hardware area executing the second instruction set, wherein:
the software area includes a dynamic compiler and a genetic algorithm engine,
the dynamic compiler generates the second instruction set, and
the genetic algorithm engine optimizes the generation of the dynamic compiler.

10. A VLIW type microprocessor according to claim 9, wherein the genetic algorithm engine is included in the dynamic compiler.

11. A VLIW type microprocessor according to claim 9, wherein:
the dynamic compiler comprises:
a means for predicting instruction branches;
a means for selecting an instruction path;
a means for scheduling an internal instruction; and
a means for optimizing the internal instruction, and
the genetic algorithm engine optimizes at least one selected from a group comprising the means for predicting, the means for selecting, the means for scheduling, and the means for optimizing.

12. A VLIW type microprocessor according to claim 9, wherein the genetic algorithm engine comprises:
a means for determining initial groups;
a means for evaluating the initial groups;
a means for selecting an object to be evaluated according to fitness of evaluation;
a means for conducting genetic operations such as crossover and mutation; and
a means for evaluating again whether the sequence of processes is continued or not.

13. A microprocessor comprising:
a static compiler translating a first instruction set to an internal instruction set;
a dynamic compiler translating the internal instruction set to a second instruction set;
a genetic algorithm engine; and
a executing unit executing the optimized second instruction set, and feeding back a execution circumstance to the dynamic compiler,
wherein the genetic algorithm optimizes the translation of the dynamic compiler with reference to the execution circumstance.

14. A microprocessor according to claim 13, wherein:
the dynamic compiler comprises:
a means for predicting instruction branches;
a means for selecting an instruction path;
a means for scheduling an internal instruction; and
a means for optimizing the internal instruction, and
the genetic algorithm engine optimizes at least one selected from a group comprising the means for predicting, the means for selecting, the means for scheduling, and the means for optimizing.

15. A microprocessor according to claim 13, wherein the genetic algorithm engine comprises:
a means for determining initial groups;
a means for evaluating the initial groups;
a means for selecting an object to be evaluated according to fitness of evaluation;
a means for conducting genetic operations such as crossover and mutation; and
a means for evaluating again whether the sequence of processes is continued or not.

16. A microprocessor comprising:
a static compiler translating a first instruction set to an internal instruction set;
a dynamic compiler translating the internal instruction set to a second instruction set;
a genetic algorithm engine; and
a executing unit executing the optimized second instruction set, and feeding back a execution circumstance to the dynamic compiler,
wherein the genetic algorithm optimizes the translation of the dynamic compiler with reference to the execution circumstance.

17. A microprocessor according to claim 16, wherein:
the dynamic compiler comprises:
a means for predicting instruction branches;
a means for selecting an instruction path;
a means for scheduling an internal instruction; and
a means for optimizing the internal instruction, and
the genetic algorithm engine optimizes at least one selected from a group comprising the means for predicting, the means for selecting, the means for scheduling, and the means for optimizing.

18. A microprocessor according to claim 16, wherein the genetic algorithm engine comprises:
a means for determining initial groups;
a means for evaluating the initial groups;
a means for selecting an object to be evaluated according to fitness of evaluation;
a means for conducting genetic operations such as crossover and mutation; and
a means for evaluating again whether the sequence of processes is continued or not.

19. A microprocessor comprising:
a means for translating a first instruction set to an internal instruction set;
a means for scheduling the internal instruction set;
a means for generating a second instruction set corresponding to the scheduled internal instruction set;
a genetic algorithm engine;
a means for storing the second instruction set; and
a means for operating the stored second instruction set,
wherein the genetic algorithm engine optimize at least one selected from a group comprising the means for translating a first instruction set, the means for scheduling the internal instruction set, and the means for generating a second instruction set.

20. A microprocessor according to claim 19, wherein the means for storing the second instruction set is a translation cache.

21. A microprocessor according to claim 19, wherein the means for operating the stored second instruction set is an operating unit.

22. A microprocessor according to claim 19, wherein the genetic algorithm engine comprises:
a means for determining initial groups;
a means for evaluating the initial groups;
a means for selecting an object to be evaluated according to fitness of evaluation;
a means for conducting genetic operations such as crossover and mutation; and
a means for evaluating again whether the sequence of processes is continued or not.

23. A microprocessor comprising:
a means for translating a first instruction set to an internal instruction set;
a means for scheduling the internal instruction set;
a means for generating a second instruction set corresponding to the scheduled internal instruction set;
a genetic algorithm engine;
a means for storing the second instruction set; and
a means for operating the stored second instruction set,
wherein the genetic algorithm engine optimize at least one selected from a group comprising the means for translating a first instruction set, the means for scheduling the internal instruction set, and the means for generating a second instruction set.

24. A microprocessor according to claim 23, wherein the means for storing the second instruction set is a translation cache.

25. A microprocessor according to claim 23, wherein the means for operating the stored second instruction set is an operating unit.

26. A microprocessor according to claim 23, wherein the genetic algorithm engine comprises:
a means for determining initial groups;
a means for evaluating the initial groups;
a means for selecting an object to be evaluated according to fitness of evaluation;
a means for conducting genetic operations such as crossover and mutation; and
a means for evaluating again whether the sequence of processes is continued or not.
